(19) United States
(12) Patent Application Publication
(10) Pub. No.: US 2015/0363214 A1
(43) Pub. Date: Dec. 17, 2015

(54) SYSTEMS AND METHODS FOR CLUSTERING TRACE MESSAGES FOR EFFICIENT OPAQUE RESPONSE GENERATION

(71) Applicant: CA, INC., Islandia, NY (US)

(72) Inventors: Miao Du, Mitcham (AU); Steven Cornelis Versteeg, Hawthorn (AU); Jean-Guy Schneider, Hawthorn (AU); Jun Han, Vermont South (AU); John Collis Grundy, Diamond Creek (AU)

(21) Appl. No.: 14/305,322

(22) Filed: Jun. 16, 2014

(51) Int. Cl. G06F 9/455; G06F 17/30

(52) U.S. Cl. CPC G06F 9/455; G06F 17/30705

(57) ABSTRACT

In a method of service emulation, ones of a plurality of messages communicated between a system under test and a target system for emulation are clustered into message clusters. A request is received from the system under test, and one of the message clusters is identified as corresponding to the request based on a distance measure. A response to the request is generated using the one of the message clusters that was identified. Related computer systems and computer program products are also discussed.

### BACKGROUND

Various embodiments described herein relate to computer systems, methods and program products and, more particularly, to virtualized computer systems, methods and computer program products.

Modern enterprise software environments may integrate a large number of software systems to facilitate complex business processes. Many of these software systems may interact with and/or rely on services provided by other systems (e.g., third-party systems or services) in order to perform their functionalities or otherwise fulfill their responsibilities, and thus, can be referred to as “systems of systems.” For example, some enterprise-grade identity management suites may support management and provisioning of users, identities, and roles in large organizations across a spectrum of different endpoint systems. Such systems can be deployed into large corporations, such as banks and telecommunications providers, who may use it to manage the digital identities of personnel and to control access of their vast and distributed computational resources and services.

Assuring the quality of such software systems (including the functionality which interacts with third-party systems or services) before deployment into actual production environments (i.e., “live” deployment) may present challenges, for example, where the systems interoperate across heterogeneous services provided by large scale environments. For example, physical replication and provisioning of real-world deployment environments can become difficult to effectively manage or even achieve, as recreating the heterogeneity and massive scale of typical production environments (often with thousands of real client and server hardware platforms, suitably configured networks, and appropriately configured software applications for the system under test to communicate with) may be difficult given the resources of a quality assurance (QA) team. Accessing these environments may also may also involve difficulty and/or expense, and the different environment configurations may affect the operational behavior of such software systems. For example, access to real third party services during testing may be restricted, expensive, and/or unavailable at a scale that is representative of the production environment. Thus, due to the complex interaction between a software system and its operating environment, traditional standalone-system-oriented testing techniques may be inadequate for quality assurance.

Enterprise software environment emulation may be used as an alternative approach to providing interactive representations of operating environments. Software service emulation (or “service virtualization”) may refer to emulation of the behavior of specific components in heterogeneous component-based environments or applications, such as API-driven applications, cloud-based applications and/or service-oriented architectures. Service virtualization allows the communication between a client and software service to be virtualized, such that the virtual service can respond to requests from the client system with generated responses. With the behavior of the components or endpoints simulated by a model or “virtual asset” (which stands in for a component by listening for requests and returning an appropriate response), testing and development can proceed without accessing the actual live components of the system under test. For instance, instead of virtualizing an entire database (and performing all associated test data management as well as setting up the database for every test session), the interaction of an application with the database may be monitored, and the related database behavior may be emulated (e.g., SQL queries that are passed to the database may be monitored, and the associated result sets may be returned, and so forth). For a web service, this might involve listening for extensible markup language (XML) messages over hypertext transfer protocol (HTTP), Java® message service (JMS), or IBM® Web Sphere MQ, then returning another XML message. Thus, the virtual asset's functionality and performance may reflect the functionality/performance of the actual component, and/or may simulate conditions (such as extreme loads or error conditions) to determine how an application or system under test responds under those circumstances.

By modeling the interaction behavior of individual systems in an environment and subsequently simultaneously executing a number of those models, an enterprise software environment emulator can provide an interactive representation of an environment which, from the perspective of an external software system, appears to be a real or actual operating environment. Manually defining interaction models may offer advantage in defining complex sequences of request/response patterns between elements of the system including suitable parameter values. However, in some cases, such an approach may not be feasible due to the time required or lack of required expertise. In particular, manually defining interaction models (including complex sequences of request/response patterns and suitable parameter values) may require knowledge of the underlying interaction protocol(s) and system behavior(s). Such information may often be unavailable at the required level of detail (if at all), for instance, when third-party, legacy, and/or mainframe systems are involved. Additionally, the large number of components and component interactions in such systems may make manual approaches time-consuming and/or error-prone. Also, due to lack of control over the environment, if an environment changes with new enterprise elements or communication between elements, these manual protocol specifications must be further updated.

### BRIEF SUMMARY

According to some embodiments, in a method of service emulation, ones of a plurality of messages communicated between a system under test and a target system for emulation are clustered into message clusters. A request is received from the system under test, and one of the message clusters is identified as corresponding to the request based on a distance measure. A response to the request is generated using the one of the message clusters that was identified. The clustering, the receiving, the identifying, and the generating may be operations performed by at least one processor.

According to further embodiments, a computer system includes a processor and a memory coupled to the processor. The memory includes computer readable program code embodied therein that, when executed by the processor, causes the processor to cluster ones of a plurality of messages communicated between a system under test and a target system for emulation into message clusters, identify one of the message clusters as corresponding to a received request from the system under test based on a distance measure, and generate a response to the request using the one of the message clusters that was identified.

According to still further embodiments, a computer program product includes a computer readable storage medium having computer readable program code embodied in the medium. The computer readable program code includes computer readable code to cluster ones of a plurality of messages communicated between a system under test and a target system for emulation into message clusters, computer readable code to identify one of the message clusters as corresponding to a received request from the system under test based on a distance measure; and computer readable code to generate a response to the request using the one of the message clusters that was identified.

It is noted that aspects described herein with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present disclosure, and be protected by the accompanying claims.

### BRIEF DESCRIPTION OF THE DRAWINGS

Aspects of the present disclosure are illustrated by way of example and are not limited by the accompanying figures with like references indicating like elements.

FIG. 1 is a block diagram of a computing system or environment for service emulation in accordance with some embodiments of the present disclosure.

FIG. 2 is a block diagram that illustrates computing device for service emulation in accordance with some embodiments of the present disclosure

FIG. 3 is a block diagram that illustrates a software/hardware architecture for service emulation in accordance with some embodiments of the present disclosure.

FIGS. 4A-4E are diagrams illustrating message analysis for clustering operations in accordance with some embodiments of the present disclosure.

FIGS. 5-6 are flowcharts illustrating methods for service emulation in accordance with some embodiments of the present disclosure.

FIG. 7 is a block diagram illustrating a cross-validation approach for service emulation in accordance with some embodiments of the present disclosure.

FIG. 8 is a block diagram illustrating an example computing system or environment for service emulation.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Peri, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. As used herein, “a processor” may refer to one or more processors.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

As described herein, a computing system or environment may include one or more hosts, operating systems, peripherals, and/or applications. Machines in a same computing system or environment may have shared memory or resources, may be associated with the same or different hardware platforms, and/or may be located in the same or different physical locations. Computing systems/environments described herein may refer to a virtualized environment (such as a cloud environment) and/or a physical environment.

In assuring quality of a system under test (for example, a large enterprise system), physical replication of real-world deployment environments may be difficult or impossible to achieve. Thus, an emulation environment where realistic interactive models of the third party services are executed may be useful for purposes of quality assurance and/or development and operations (DevOps). While hardware virtualization tools (such as VMware and VirtualBox) may be capable of replicating specific facets of deployment environments using virtual machines (i.e., software implementations that emulate the architecture and/or program execution of the underlying physical machines), such virtualization tools may have similar scalability limitations as physical recreation of deployment environments (for instance, a virtual CPU-to-physical core ratio on the order of ten to one or less may be required). Mock objects may be used to mitigate some of the scalability concerns, but may be too language-specific and/or may require re-implementation of some of an environment's functionality, which may result in testing environment configuration and maintenance problems and/or may require detailed knowledge of environment components. Performance and load testing tools may allow for emulation of thousands of software system clients with limited resources; however, such tools are typically designed to generate scalable client load towards a target system, rather than the system under test to environment load scaling that is typically helpful in testing enterprise systems.

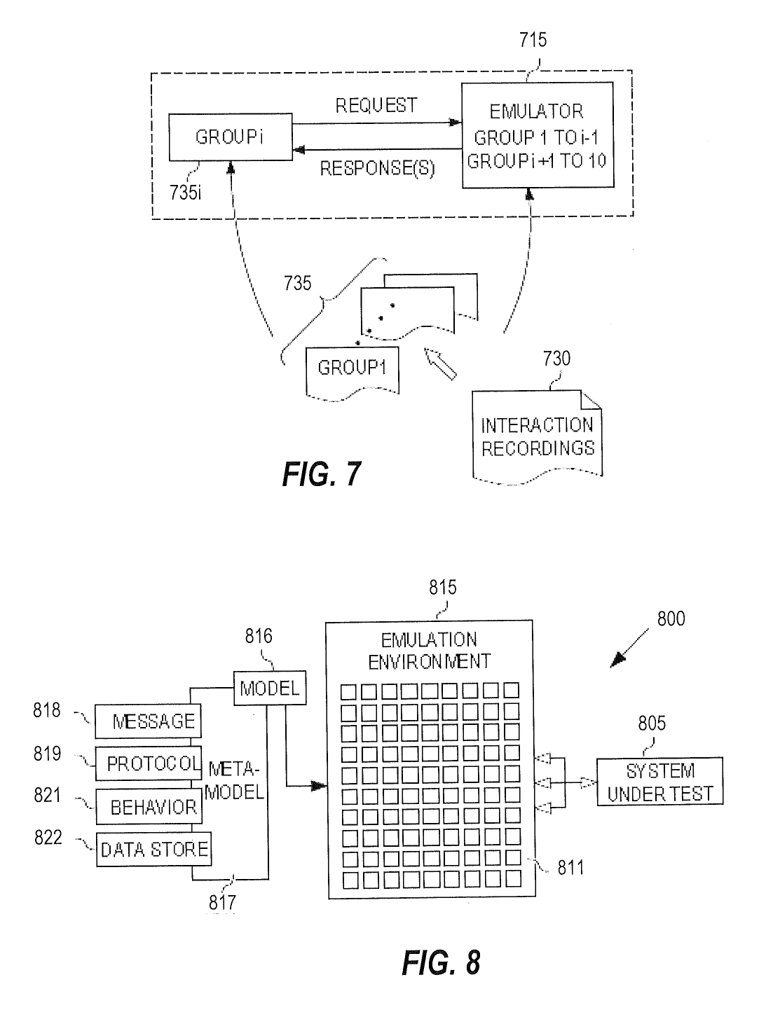

As such, emulated or “virtual” deployment environments may be used to provision representations of diverse components, as shown in the environment 800 of FIG. 8. Such an environment 800 may allow a system under test 805 to interact with a large-scale heterogeneous emulation environment 815, which can be provided by a software environment emulator. The emulation environment 815 is capable of simultaneously emulating multiple (e.g. on the order of hundreds or thousands) endpoint systems 811 on one or more physical machines, and may employ scalable models 816 to allow for scalability and performance testing. The models 816 may be created from meta models 817, which may be constructed from messages 818, protocols 819, behavior 821, and/or data store(s) 822.

However, in some instances, scaling of the environment 815 to handle the number of likely endpoints 811 in the deployment scenario may require pre-existing knowledge of (i) a likely maximum number of endpoints; (ii) the likely maximum number of messages between endpoint and system; (iii) the likely frequency of message sends/receives needed for the system to respond in acceptable timeframe; (iv) the likely size of message payloads given deployment network latency and bandwidth; and/or (v) the system's robustness in the presence of invalid messages, too-slow response from end-points, or no-response from endpoints. Also, messages being exchanged between the system under test 805 and the endpoints 811 should adhere to various protocols; for example, a Lightweight Directory Access Protocol (LDAP) message sent by the system under test 805 to an endpoint 811 should be responded to with a suitable response message in reply, in an acceptable timeframe and with acceptable message payload. Subsequent messages sent by the system under test 805 to the endpoint using the LDAP response message payload may also need to utilize the previous response information. As such, the creation of such executable endpoint models 811 may require the availability of a precise specification and/or prior detailed knowledge of the interaction protocols 819 used, may be relatively time consuming and/or error-prone, and may be subject to considerable implementation and/or maintenance effort in heterogeneous deployment environments.

Protocol reverse engineering may be used to determine such interaction protocols 819. By analyzing a large amount of packets and traces captured on networks, structure information of the target protocol may be obtained for network analysis and even automatically reverse engineering the state-machine model of network protocols. For example, an emulator may be used to mimic client- and/or server-side behaviors. With the emulator, the interactions of web applications may be recorded and replayed to ensure conformance of web server behaviors.

LISA® is a commercial service virtualization software product which can emulate the behavior of services with which a system under test interacts in its deployment environment, by mimicking responses that an actual service would produce in response to receiving a request from the enterprise system under test. After recording a set of actual interactive message exchanges (including requests and responses; also referred to herein as interaction traces or message transactions) between a system under test and an endpoint in a transaction library (also referred to as a service image), LISA can use the stored interactions to produce responses to further requests, thus behaving as a ‘virtual’ service. LISA may consider the interaction state when sending a response, and may use field substitution in the responses for fields that are detected as identical in the request and response. However, for the modeling to be effective, LISA may require information regarding the transport protocol and/or the service protocol (or other specification of the message structure) to be known in advance of the recording. In other words, prior knowledge of the service protocol and/or message structure may be required.

Software service emulation as described herein can create realistic executable models of server-side behavior, thereby replicating production-like conditions for large-scale enterprise software systems. Some embodiments of the present disclosure are directed to a service emulation or virtualization approach that is configured to deduce or infer enterprise system element interaction behavior (agnostic to or without pre-existing knowledge of protocols or message structures) by monitoring and mining message transactions (also referred to as interaction traces) communicated between a system under test and endpoint or elements/components in its deployment environment, to automatically build a transaction database or library indicative of client-server and/or server-server interactions.

More particularly, responsive to receiving an incoming request from a system under test, embodiments of the present disclosure (i) search for a suitably similar request in the previously recorded transactions (including requests and responses) stored in the transaction library, (ii) identify commonalities and differences between the incoming request and the previously-recorded messages (or messages representative thereof), and (iii) generate a response based on one(s) of the previously recorded responses associated with the previously recorded request(s) having the identified commonalties and differences. Longest common subsequence matching and field substitution may also be used to implement a distance function and a translation function, respectively, to generate the response to the incoming request. For example, given an incoming request to a modeled service, the distance function may be used to search for the most similar request in the previously recorded interaction traces by computing their distances, and the translation function may be

used to synthesize a valid response.

Various embodiments described herein can thus provide service emulation or virtualization methods, systems, and/or computer program products that simulate the behavior of a target environment responsive to a request from a system under test, by building a library of previous requests and responses thereto, and generating or synthesizing a protocol-conformant response to the received request based on similarities and differences between the received request and the previous requests stored in the library. That is, automatic modeling approaches described herein can synthesize protocol conformant responses by mining interaction traces in order to mimic the interaction behavior among enterprise system components. Such embodiments allow for response generation without pre-existing knowledge of (that is, without receiving, processing, or otherwise independently of data explicitly indicating) a structure and/or protocol associated with the incoming message, and are thus referred to herein as “opaque” service virtualization or emulation.

Some embodiments of the present disclosure may enable synthesis of a protocol definition based on recordation and analysis of actual message transactions, deduction of a corresponding (i.e., similar but not necessarily identical) and/or best-matching response message (and suitable payload) upon receiving a message at an emulated endpoint, and generation of a reply to the sending system under test with the appropriate message and payload synthesized based on the analysis and matching. In particular, when an enterprise software system interacts with another system in its deployment environment, observable interaction behaviors, which are referred to herein as interaction traces or message transactions, may be recorded by a network sniffer tool, a proxy or a gateway. As a valid interaction typically conforms to a specific protocol specification, the interaction traces may contain precise information, for example, in terms of sequences of request/response patterns, including but not limited to parameter values and potential temporal properties. Embodiments of the present disclosure thereby infer or deduce enterprise system element interaction behaviors indirectly, through operation on the stored message transactions. While not required, particular embodiments may function by processing interaction traces in order to extract sufficient protocol information therefrom, creating interaction models based on extracted information, and using the created interaction models to communicate with the system under test in the production environment, thereby emulating behavior of the actual systems for quality assurance purposes.

Some embodiments of the present disclosure arise from realization that, as the accuracy of the generated responses in opaque service virtualization may rely on processing and analyzing the recorded interaction traces, efficiency issues may result as the number of interaction traces to be analyzed increases. For example, when a library or database (also referred to herein as a transaction library) contains a large number of interaction traces, searching the entire library to generate run-time responses can become very slow.

As such, some embodiments of the present disclosure use data mining, specifically clustering algorithms, to analyze large amounts or quantities of recorded interaction trace data. In particular, embodiments of the present disclosure use a clustering-based method for the trace analysis function in the pre-processing stage. Given a collection of interaction traces, embodiments of the present disclosure (i) calculate the distance between pairwise interactions and build a distance matrix; (ii) cluster interactions; and (iii) export the clusters and infer the cluster centers for use later in the process. In particular embodiments, the Needleman-Wunsch algorithm may be used as the distance measure, and two clustering algorithms, BEA and VAT, may be used to cluster the interactions. Any alternative clustering algorithm may also be used, such as K-Means, density based clustering algorithms, or hierarchical clustering algorithms. With the obtained clusters, efficient yet well-formed runtime response generation may be facilitated in an Enterprise System emulation environment. The effectiveness and efficiency of response synthesis as described herein were evaluated after pre-processing recorded interaction traces of two widely used application-layer protocols: LDAP and SOAP. Experimental results show that, by utilizing clustering techniques in the pre-processing step as described herein, response generation time can be reduced by up to about 99% on average compared with existing approaches.

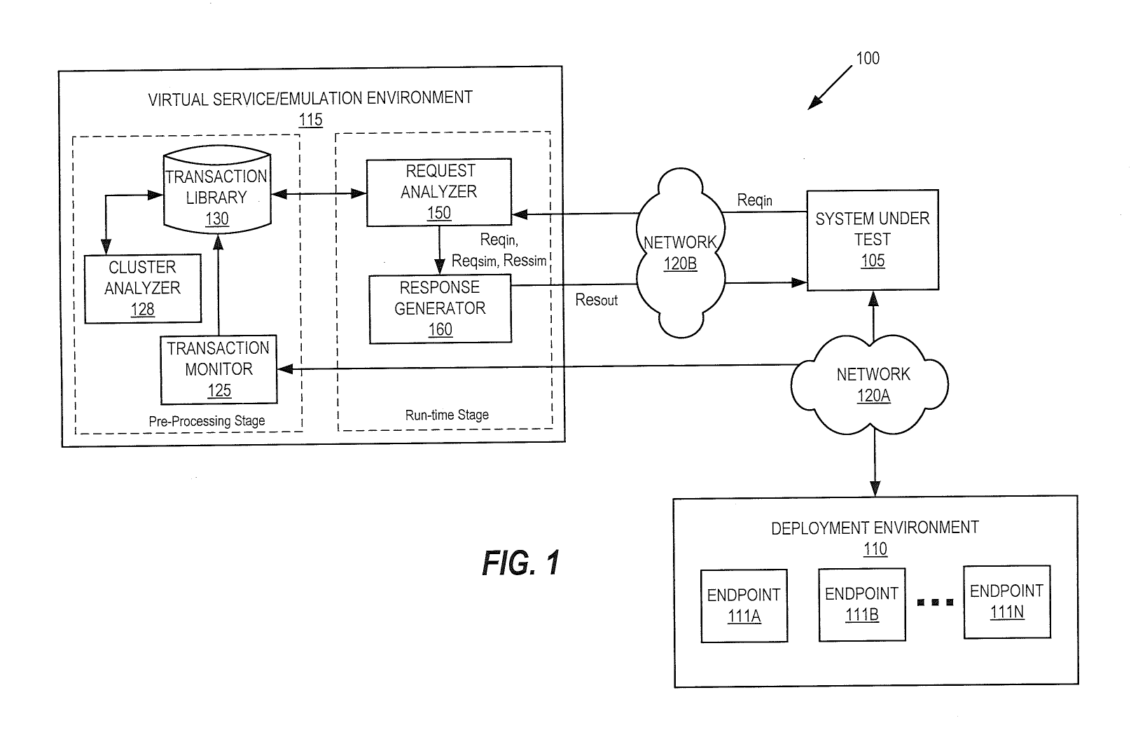

FIG. 1 is a block diagram illustrating a computing system or environment for opaque service emulation in accordance with some embodiments of the present disclosure. Referring now to FIG. 1, the environment 100 includes a system under test 105, a deployment environment 110 including a plurality of endpoints 111A, 111B, . . . 111N, and a virtual service environment (also referred to herein as an emulation environment) 115. The deployment environment 110 may include one or more software services upon which the system under test 105 depends or otherwise interacts to fulfill its responsibilities. The emulation environment 115 includes a transaction monitor 125, a cluster analyzer 128, a request analyzer 150, a response generator 160, and a message transaction library 130. The message transaction library 130 stores a set of message transactions (including requests and associated responses; generally referred to herein as messages) sampled from prior communications with (i.e., to and/or from) a client (here, the system under test 105) and a target service for emulation or virtualization (here, the deployment environment 110).

The environment 100 of FIG. 1 operates as follows. The system under test 105 is observed communicating with endpoint(s) 111A, 111B, . . . 111N in a deployment environment 110 via a transaction monitor 125, for example, in a pre-processing stage. The transaction monitor 125 may include or implement a network monitoring tool, such as Wireshark®, for monitoring communications between the system under test 105 and the endpoint(s) 111A, 111B, . . . 111N. The system under test 105 and the endpoint(s) 111A, 111B, . . . 111N communicate via a network 120A using a communications mode or protocol, such as Lightweight Directory Access Protocol (LDAP) messages or Simple Object Access Protocol (SOAP) messages, which may be conveyed using Hypertext Transport Protocol (HTTP) with an Extensible Markup Language (XML) serialization.

The transaction monitor 125 records message transactions (including requests and responses thereto) communicated with (i.e., to and/or from) the system under test 105, in particular, between the system under test 105 and the endpoint(s) 111A, 111B, . . . 111N, for example, using a network sniffer tool. The transaction monitor 125 stores these message transactions in the transaction library 130. For example, the transaction monitor 125 may store the transactions between the system under test 105 and the endpoint(s) 111A, 111B, . . . 111N in the transaction library 130 as request/response pairs. For a given protocol, a number of interactions between the system under test 105 and the endpoint(s) 111A, 111B, . . . 111N are recorded, as may be needed for response generation as discussed below. The transaction monitor 125 may also be configured to filter network traffic such that messages of interest may be recorded in a suitable format for further processing. In some embodiments, the transaction monitor 125 may be configured to record the message transactions between the system under test 105 and the endpoint(s) 111A, 111B, . . . 111N in the library 130 without knowledge of structural information (which may indicate the protocol, operation type, and/or header information) of the requests/responses. After the transactions have been recorded, the cluster analyzer 128 may be configured to align the messages in the transaction library 130 in a manner suitable for comparison of characters, byte positions, n-grams, and/or other portions thereof, in order to cluster similar ones of the messages as described herein. The transaction library 130 thus provides historical transaction data for the system under test 105, which is used as a source for protocol analysis and response generation as described in greater detail herein.

In the pre-processing stage, operations may also be performed to distinguish protocol information (i.e. message structural information defined by a particular protocol specification) from payload information (i.e. variables that are produced/consumed by application programs) by further analysis of the messages stored in the transaction library 130, which may increase accuracy and efficiency. For example, in some embodiments, protocol information may be distinguished from payload information based on the relative character lengths of sections of the stored messages (as payload sections may typically include more characters/may be “longer” than protocol sections), and/or based on the relative variability of sections of the stored messages (that is, based on the entropy of the sections relative to one another). In particular, the stored messages may be pre-processed in order to define clusters of similar messages. For a large transaction library, searching every transaction for the closest matching message can be time consuming; thus, clustering the transaction library can reduce the number of messages to be searched (i.e., rather than searching every transaction in the library 130, only the clusters or representative messages of each cluster may be searched). Thus, cluster generation as described herein can make response generation more efficient, which may allow responses to be generated in real-time.

As shown in FIG. 1, embodiments of the present invention provide an analysis function (illustrated as a cluster analyzer 128) that is configured to select and provide representative message transaction data to a distance function and a translation function (illustrated as a request analyzer 150 and a response generator 160), thereby accelerating response generation time at run-time. A framework according to some embodiments is split into 2 consecutive stages, that is, the pre-processing stage and the run-time stage shown in FIG. 1. At the pre-processing stage, the cluster analyzer 128 is used to partition the transaction library 130 into “clusters” of similar messages, using a data clustering method. Any clustering method may be used, such as the Visual Assessment of cluster Tendency (VAT), Bond Energy Algorithm (BEA), K-Means, a hierarchical clustering algorithm, etc. The clustering method may include human supervision (such as in VAT) or may be fully automated in some embodiments. The similarity is determined by a distance function (such as the Needleman-Wunsch sequence alignment algorithm). The distance function may be applied to cluster the messages based on request similarity, response similarity, or a combination of the request and response similarities. The distance function may also weight different parts of the messages differently. For example, different weightings may be assigned to respective sections of the messages based on a relative variability of the position relative to other messages in the transaction library thereof as an indicator of respective information types contained therein, as discussed in detail in commonly-owned U.S. patent application Ser. No. 14/211,933 entitled “ENTROPY WEIGHTED MESSAGE MATCHING FOR OPAQUE SERVICE VIRTUALIZATION,” the disclosure of which is incorporated by reference herein.

The cluster analyzer 128 is further configured to determine representative messages (referred to herein as cluster prototypes) for each of the message clusters. The cluster prototypes summarize and/or indicate characteristics of the messages in each cluster. For example, the prototype may be a sample message selected from among the messages of a cluster (such as a centroid message that is determined based on the relative distances of the messages in that cluster), or may be a summary message generated by the cluster analyzer 128 that includes common patterns of messages in the corresponding cluster. The cluster prototypes selected and/or generated for each message cluster may be used at the run-time stage to increase the efficiency of response generation.

The request analyzer 150 and a response generator 160 operate at the run-time stage, using the message clusters generated by the cluster analyzer 128. In particular, as shown in FIG. 1, when running QA tests against the system under test 105 (i.e., at the run-time stage), the emulation environment 115 may receive a request Reqᵢₙ from the system under test 105 at the request analyzer 150 via a network 120B. The request analyzer 150 is configured to access the transaction history stored in the library 130 to indirectly identify potential valid response messages based on cluster prototypes that match the received request Reqᵢₙ, without knowledge or determination of the structure or protocol of the received request Reqᵢₙ. For example, the identifying may be performed at run-time without an understanding of the contents of the request, and without pre-processing of the received request Reqᵢₙ. In some embodiments, the request analyzer 150 may employ one or more algorithms, such as a distance function, to compare the current request Reqᵢₙ received from the system under test 105 to the respective cluster prototypes for each message cluster to identify one of the message clusters as corresponding to the current request Reqᵢₙ. Results (Reqₛᵢₘ, Resₛᵢₘ) of the analysis by the request analyzer 150 (for example, indicating the closest-matching cluster prototype or a closest request/response pair selected from the identified message cluster) are provided to the response generator 160. It will be understood that, as used herein, a “matching” or “corresponding” cluster prototype, message, request, and/or response, as determined for example by the request analyzer 150, may refer to a prototype/message/request/response that is similar (but not necessarily identical) to the request Reqᵢₙ received from the system under test 105.

The response generator 160 is configured to synthesize or otherwise generate a response message Resₒᵤₜ based on the results (Reqₛᵢₘ, Resₛᵢₘ) and the incoming request Reqᵢₙ using one or more algorithms, such as a translation function, as described in greater detail below. The response generator 160 thereby returns the generated response Resₒᵤₜ to the system under test 105, and the system under test 105 consumes or otherwise processes the generated response Resₒᵤₜ and continues running. Thus, the response Resₒᵤₜ is automatically generated using the received request Reqᵢₙ from the system under test 105 based on the request/response pairs stored in the transaction library 130, in contrast to some existing emulation approaches, where requests received by the emulation environment may be processed using (typically) manually-specified scripts to generate a response. The automatically generated response Resₒᵤₜ is returned to the system under test 105 via the network 120B.

It will be appreciated that in accordance with various embodiments of the present disclosure, the emulation environment 115 may be implemented as a single server, separate servers, or a network of servers (physical and/or virtual), which may be co-located in a server farm or located in different geographic regions. In particular, as shown in the example of FIG. 1, the emulation environment 115 is coupled to the system under test 105 via network 120B. The deployment environment 110 may likewise include a single server, separate servers, or a network of servers (physical and/or virtual), coupled via network 120A to the system under test 105. The networks 120A, 120B may be a global network, such as the Internet or other publicly accessible network. Various elements of the networks 120A, 120B may be interconnected by a wide area network (WAN), a local area network (LAN), an Intranet, and/or other private network, which may not be accessible by the general public. Thus, the communication networks 120A, 120B may represent a combination of public and private networks or a virtual private network (VPN). The networks 120A, 120B may be a wireless network, a wireline network, or may be a combination of both wireless and wireline networks. Although illustrated as separate networks, it will be understood that the networks 120A, 120B may represent a same or common network in some embodiments. As such, one or more of the system under test 105, the deployment environment 110, and the emulation environment 115 may be co-located or remotely located, and communicatively coupled by one or more of the networks 120A and/or 120B. More generally, although FIG. 1 illustrates an example of a computing environment 100, it will be understood that embodiments of the present disclosure are not limited to such a configuration, but are intended to encompass any configuration capable of carrying out the operations described herein.

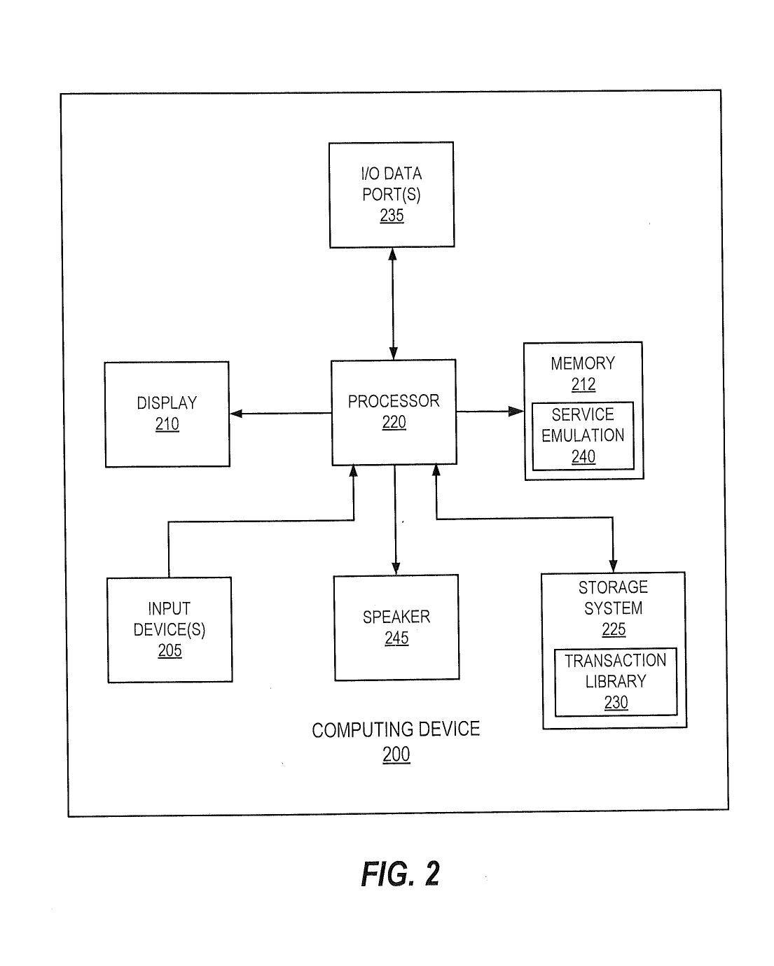

FIG. 2 illustrates an example computing device 200 in accordance with some embodiments of the present disclosure. The device 200 may be used, for example, to implement the virtual service environment 115 in the system 100 of FIG. 1 using hardware, software implemented with hardware, firmware, tangible computer-readable storage media having instructions stored thereon, or a combination thereof, and may be implemented in one or more computer systems or other processing systems. The computing device 200 may also be a virtualized instance of a computer. As such, the devices and methods described herein may be embodied in any combination of hardware and software.

As shown in FIG. 2, the computing device 200 may include input device(s) 205, such as a keyboard or keypad, a display 210, and a memory 215 that communicate with one or more processors 220 (generally referred to herein as “a processor”). The computing device 200 may further include a storage system 225, a speaker 245, and I/O data port(s) 235 that also communicate with the processor 220. The memory 212 may include a service emulation module 240 installed thereon. The service emulation module 240 may be configured to mimic the behavior of a target system for emulation in response to a request or other message received from a system under test, as described in greater detail herein.

The storage system 225 may include removable and/or fixed non-volatile memory devices (such as but not limited to a hard disk drive, flash memory, and/or like devices that may store computer program instructions and data on computer-readable media), volatile memory devices (such as but not limited to random access memory), as well as virtual storage (such as but not limited to a RAM disk). The storage system 225 may include a transaction library 230 storing data (including but not limited to requests and associated responses) communicated between a system under test and a target system for emulation. Although illustrated in separate blocks, the memory 212 and the storage system 225 may be implemented by a same storage medium in some embodiments. The input/output (I/O) data port(s) 235 may include a communication interface and may be used to transfer information in the form of signals between the computing device 200 and another computer system or a network (e.g., the Internet). The communication interface may include a modem, a network interface (such as an Ethernet card), a communications port, a PCMCIA slot and card, or the like. These components may be conventional components, such as those used in many conventional computing devices, and their functionality, with respect to conventional operations, is generally known to those skilled in the art. Communication infrastructure between the components of FIG. 2 may include one or more device interconnection buses such as Ethernet, Peripheral Component Interconnect (PCI), and the like.

In communications between two system elements, such as the system under test 105 and the deployment environment 110, both should adhere to a particular protocol specification. It can be inferred that the observable message transactions contain information regarding this protocol specification, also referred to herein as structural information. However, in addition to such structural information, transmitted messages often deliver user data (also known as payloads) that may be consumed/produced by an application using the particular protocol, in order to exchange messages with another application. Message transaction analysis may thus be used by the service emulation module 240 to distinguish protocol-related information (i.e. message format/structure) from application-specific information (i.e. payload) with little or no prior knowledge of the particular protocol used in the message transaction.

In some embodiments, the service emulation module 240 may be configured to pre-process the message transactions stored in the transaction library 230 to investigate widely-used application-layer protocols. Doing so may provide insight into both message structures and encoding rules of available protocols, thereby obtaining a set of heuristic rules for inference purposes. Specifically, if the stored message transactions inherently conform to a protocol whose message structures and encoding rules have been well defined, the messages may be associated with this particular protocol automatically. If, on the other hand, the stored message transactions do not conform to any known protocols, a relevant rule may be automatically selected and a new heuristic rule set may be composed.

One or more distance functions may be used by the service emulation module 240 to indirectly identify similar ones of the stored requests/responses (for cluster generation) and/or a request from an identified cluster that corresponds to an incoming request (for response generation) based on a measure of similarity, rather than based on knowledge of the underlying structure. One notion of similarity used in some embodiments of the present disclosure is the edit distance between two sequences s1 and s2, which indicates the minimum number of modifications (insertions, deletions, and/or substitutions) in order to obtain s2 from s1. That is, the distance function may be used to compute the number of modifications or alterations among the stored requests/responses (such that ones having similar or lowest relative distances can be grouped in the same cluster) and/or the number of modifications or alterations to the incoming request required to arrive at the requests of the identified cluster (such that the request having the lowest distance can be selected for response generation). In some embodiments, different distance functions may be automatically selected for cluster generation and response generation, for example, based on a particular notion of similarity and/or a particular protocol. Depending on the distance function selected, different ones of the stored requests/responses and/or requests from an identified cluster may be chosen to be the most “similar”. In some embodiments, the similarity may be calculated using a distance function that is weighted based on different weightings of respective character positions, as discussed in detail in commonly-owned U.S. patent application Ser. No. 14/211,933 referenced above.

A translation function may be used by the service emulation module 240 to generate or synthesize a valid response to an incoming request. The validity of a generated response may depend on the message structure, as the sequence of transmitted messages typically adhere to a particular protocol specification that is used by an application on one host to exchange data with its communicating partner on other host(s) over the network. The validity of the generated response may also depend on the synthesis of payloads that can be recognized, extracted, and/or further processed by its communicating partner. As both the protocol- and the application-related information may be distinguished by the pre-processing and/or distance calculation, the translation function may be configured to automatically structure messages in the expected format and fill in payload contents.

As mentioned above, in an enterprise system emulation environment (such as the environment 100 of FIG. 1), a request Reqᵢₙ (sent from the enterprise system under test) should be responded to by the emulated operating environment (such as the emulation environment 115) according to the various interaction protocols between the components of the deployment environment (such as the deployment environment 110). Such interaction protocols include LDAP, HTTP/HTTPS, SOAP, SMTP, SMB, etc. In an emulation environment, a request message Reqᵢₙ sent from an enterprise system under test is responded to with a generated response message Resₒᵤₜ, rather than an actual response message from the deployment environment. This allows a complex, large-scale emulation environment to be provided to the system under test without the scalability and configuration limitations of other techniques. However, the technique is critically dependent on the ability of the emulation environment to generate realistic responses to the requests.

The observable interaction request messages and response messages communicated between a system under test and a target system contain two types of information: (i) protocol structure information (such as the operation name), used to describe software services behaviors; and (ii) payload information, used to express software systems' attributes. In general, given a collection of message interactions conforming to a specific interaction protocol, the repeated occurrence of protocol structure information may be common, as only a limited number of operations are defined in the protocol specification. In contrast, payload information is typically quite diverse according to various interaction operation parameter values. Message transaction analysis may thus be used to infer protocol-related information from application-specific information by comparing sections of messages, without prior knowledge of the particular protocol used in the message transaction.

In embodiments of the present invention, one or more algorithms are used to classify large numbers of message interactions (e.g., thousands or even millions) into groups or message clusters, to assist and/or reduce the burden in searching for the most similar recorded messages for an incoming request. At a high level, these algorithms can be viewed as an application of clustering and sequence alignment techniques for inferring protocol structure information. In particular, if some requests/responses are less distant (i.e., have similar relative distances) to other requests/responses, then it can be inferred that the less distant requests/responses are more likely to have the same or similar structure information. Hence, computing the distance between each request/response pair may indicate how to classify recorded message interactions into respective message clusters, which may enable more efficient generation of responses that are closer to the expected responses.

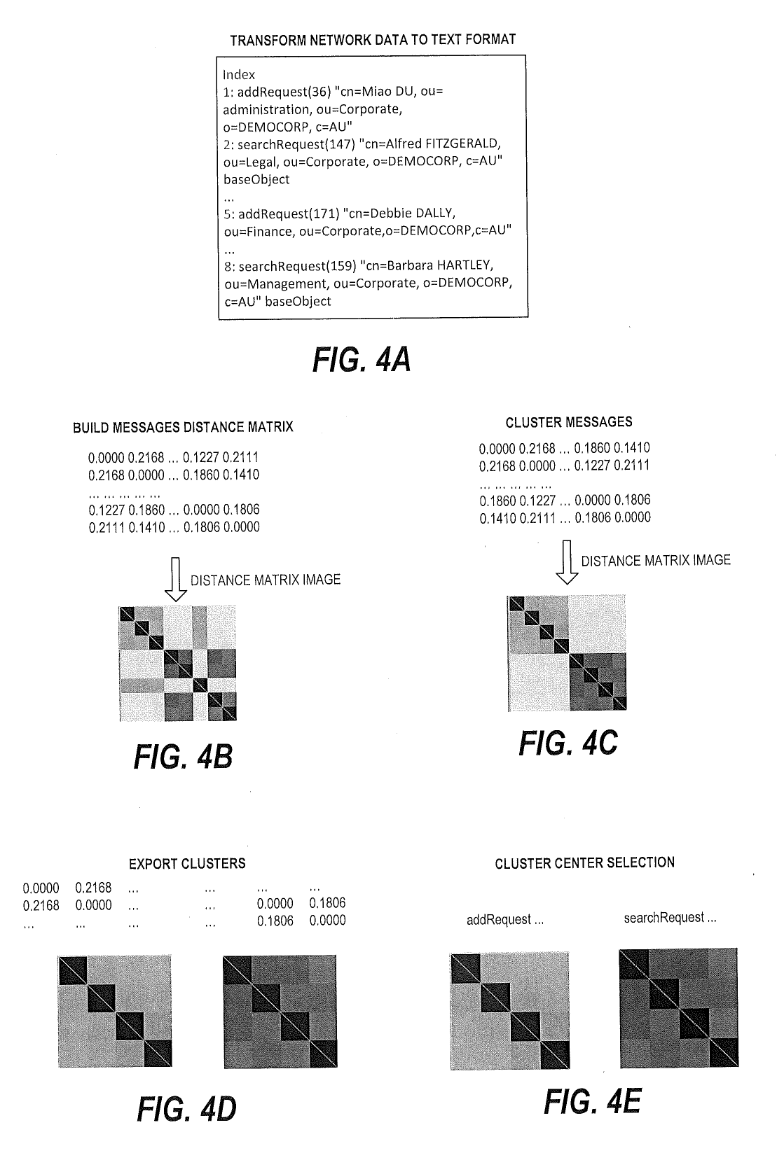

FIGS. 4A-4E are diagrams illustrating message analysis for clustering operations in accordance with some embodiments of the present disclosure. Referring now to FIG. 4A, network traffic is transformed to a suitable format for further processing. In particular, in FIG. 4A, raw network data is translated to a corresponding text format. Such data may be stored, for example, as request/response pairs, in a transaction library as described herein. Relative distances between the stored request/response pairs are calculated using a distance function, and a distance matrix containing the calculated distances between the message pairs in the transaction library is generated, as shown in FIG. 4B, FIG. 4C illustrates that the distance matrix provides a basis for further clustering. In particular, in FIG. 4C, a clustering algorithm is applied to the distance matrix. According to clustering results, some or all of the messages stored in the transaction library can be classified into a number of groups or message clusters. As shown in FIG. 4D, each of the message clusters includes request/response pairs having smaller relative distances therebetween. FIG. 4E illustrates that, for each message cluster, a representative message (also referred to herein as a cluster ‘center’ or prototype) is automatically selected to represent each message cluster.

In the translation operations of FIG. 4A, for a given protocol under investigation, a sufficiently large number of message interactions (e.g., requests and responses) between two (or more) deployed software endpoints or components were recorded, for example, in a transaction library as described herein. The recordings are assumed to be “valid”, that is, the sequence of recorded message interactions (i) are correct with regards to the temporal properties of the underlying protocol, and that (ii) each request and response message is well-formed, Without loss of generality, it is assumed that each request is followed by a single response. If a request does not result in a response, a dedicated “no-response” message is inserted into the recorded interaction traces. If, on the other hand, a request results in multiple responses, these responses are concatenated into a single response.

Given these assumptions, (R_{eq}, Rₑₛ) denotes a request/response pair of a single message transaction, where R_{eq} represents the request, and the corresponding response to R_{eq} is defined by Rₑₛ. Both R_{eq} and Rₑₛ are a sequence of characters describing the message structure and payload. An interaction trace is defined as a finite, non-empty sequence of interactions, which is denoted by ((R_{eq}, Rₑₛ₁), (R_{eq2}, Rₑₛ₂) . . . (R_{eqn}, Rₑₛₙ)). Tools such as Wireshark® may have the functionality to filter network traffic and record interactions of interest in a suitable textual format for further processing, for example, in the form of R_{eq}#Rₑₛ, followed by a line break. The recorded transactions may also be processed by the service emulation system (that is by the clustering, matching and translation modules) in their binary format, that is, without any transformation.

In generating the distance matrix of FIG. 4B, given a sufficient number of interactions in suitable formats, a distance or “similarity” between the requests and/or responses of the recorded interaction traces/message transactions may be determined using one or more distance measures or functions. As noted above, one such measure, based on sequence alignment, is known as the Needleman-Wunsch algorithm, and has been used in the area of bioinformatics in order to determine similarities in the amino acid sequences of proteins. In particular, sequence alignment may be used to align all common subsequences of two sequences under comparison, and to insert gaps into either of the sequences when they differ. In order to avoid random alignments of a small size, the algorithm may be modified in such a way that a minimum length may be required in order to identify common subsequences as such.

The following illustrates an example of message alignment in accordance with some embodiments described herein. Consider the following two text sequences:

Where is my computer book?

Where is your computer magazine?

The common subsequences are “Where is”, “computer”, and “?”, while “my” versus “your” and “book” versus “magazine” are the differing parts of the two sequences. The fully aligned sequences will be as follows (where the character “*” denotes an inserted gap):

Where is my*** computer book*******?

Where is * your computer ****magazine?

The distance between these two example text sequences may be defined by the number of gaps inserted to both sequences in the alignment process.

Based on the alignment results, the distance measure is defined as:

dist(msg,msg′)=N_{mismatch}/(N_{alg}+N′_{alg}−N_{mismatch}) (1)

where N_{alg} and N′_{alg} denote the number/quantity of characters (including inserted gaps) in the sequence alignment for msg, msg′, and N_{mismatch} represents the total number of inserted gaps. Therefore, 16/(37+37−16)=0.275 is the distance in the example given above. An N×N symmetrical distance matrix DM may be constructed by iteratively computing the distance for all the candidate requests/responses, where N is the total number of requests/responses.

In clustering the messages in FIG. 4C, once the distance matrix DM has been constructed, the calculated distances are used to group the requests/responses into message clusters. In particular, one or more clustering algorithms are applied to the distance matrix, thereby producing clusters including requests/responses having similar character sequences. Some example embodiments described herein focus on distance matrix reordering as a first step to achieve the clustering, in particular, utilizing the BEA and VAT clustering algorithms. These algorithms do not require definition of the number of clusters or a distance threshold value in advance, as may be needed with some other clustering methods, such as K-Means.

More particularly, the BEA (Bond Energy Algorithm) may be used to cluster large data sets. Given a distance matrix, it can group similar items along the matrix diagonal by permutating rows and columns to maximize the following global measure equation (2), denoted by GM:

GM=Σⁿᵢ₌₁Σⁿⱼ₌₁(1−DMᵢⱼ)(2−DM_{i,j-1}−DM_{i,j+1}) (2)

where DMᵢⱼ denotes the distance between msgᵢ and msgⱼ.

The VAT (Visual Analysis of Cluster Tendency) is a visual method, which works on a pairwise distance matrix D. This algorithm utilizes a modified version of Prim's minimal spanning tree to reorder the rows and columns of the distance matrix. The reordered matrix is displayed as a gray-scale image, as shown in FIG. 4C. Using the BEA algorithm and/or the VAT algorithm to reorder the distance matrix DM may enable users to classify messages based on the matrix image, rather than based on prior knowledge of and/or experties in the underlying protocol.

FIG. 4E illustrates selection of a representative message for each message cluster, also referred to herein as a cluster prototype. For example, the cluster prototype may be a centroid message or ‘center’ of the cluster. The representative center is denoted herein by centerᵢ for every clusterᵢ, and may be used to reduce or minimize Σⁿₖ₌₁ dist(centerᵢ, msgₖ), where n denotes the number of messages in clusterᵢ, and msgₖ represents one of the messages in clusterᵢ. When a request Reqᵢₙ is received, a matching function may be used to identify which of the message clusters most closely corresponds to the incoming request Reqᵢₙ, by comparing the request Reqᵢₙ with the representative center or other prototype for each message cluster using at least one distance measure or function as described herein.

After the message cluster most closely corresponding to the incoming request Reqᵢₙ is identified (based on the similarity of its representative cluster center or other prototype), a request among the messages of the identified message cluster may be selected for use in response generation. For example, the representative request may correspond to the center for the identified cluster (referred to herein as the “Center Only” method), or may be a closest-matching one of the requests in the identified cluster (referred to herein as the “Whole Cluster” method). Specifically, given an incoming request Reqᵢₙ, the Center Only method directly uses the selected cluster center as its most similar request Reqₛᵢₘ, while Whole Cluster method uses a further matching function to search for the most similar request Reqₛᵢₘ among the messages of the identified message cluster.

A translation function as described herein may be used to generate or synthesize a response for the incoming request, by exploiting commonalities between the incoming request, its closest-matching representative request (denoted herein as Reqₛᵢₘ), as well as the associated response (denoted herein as Resₛᵢₘ). In processing an incoming, unknown request from a system under test, some embodiments of the present disclosure use an approach where, if the incoming request is similar to one of the recorded or generated requests, then the response should also be similar to a previously recorded or generated response associated with the similar one of the recorded or generated requests. Hence, identifying the differences between the incoming and previously recorded requests may provide an indication how the associated recorded response can be altered in order to synthesize a valid response.

In some embodiments, common subsequence identification may be relied upon. In particular, it is noted that many protocols encode information in request messages that are subsequently used in associated responses. For example, application-level protocols such as LDAP add a unique message identifier to each request message, where the associated response message should also contain the same message identifier in order to be seen as a valid response. Therefore, to synthesize responses for LDAP (or similar protocols) in accordance with some embodiment of the present disclosure, the message-id from the incoming request may be copied into the associated one of the recorded response messages. Similarly, information associated with a specific request operation (e.g., a search pattern for a search request) may be “copied” across from the request to its response. For example, some recorded interaction traces between an LDAP client and server may contain a search request for all entries with the name “Baker.” If an incoming request defines a search for all entries with the name “Parker,” then the two requests can be considered to be similar (as both are search requests; only the name is different). Hence, in generating a search result in response to the request for “Parker”, all occurrences of “Baker” in the recorded interaction traces may be replaced with “Parker”, and the LDAP message-id may be adjusted accordingly, such that the altered response to the recorded search for “Baker” may be a sufficient response to the search for “Parker” for emulation purposes. Such information is referred to herein as symmetric fields, and the copying of such information from an incoming request in generating a response is referred to herein as symmetric field substitution.

The common subsequence algorithm described above may be used to identify symmetric fields, that is, the common subsequences between a request and its associated response. However, as the symmetric fields may not appear in the same order and/or cardinality, simple sequence alignment may be problematic. Instead, an alignment matrix may be used to identify common subsequences. In order to avoid small and/or random common subsequences, a threshold sequence length (based on a number/amount of characters) may be defined as to when a common sequence of characters is considered a symmetric field. Once the symmetric fields between Reqₛᵢₘ and Resₛᵢₘ are determined, the corresponding field information may be identified in the incoming request Reqᵢₙ and substituted in Resₛᵢₘ in order to synthesize the final response Resₒᵤₜ.

The following example illustrates the identification of symmetric fields and how symmetric fields are used in the response generation process in accordance with some embodiments of the present disclosure. Consider the following incoming LDAP search request:

Message ID: 18

ProtocolOp: searchRequest
ObjectName: cn=Mal BAIL,ou=Administration,
   ou=Corporate,o=DEMOCORP,c=AU
Scope: 0 (baseObject)
   In generating a response to the above request, a search for the most similar/closest matching request among the recorded interaction traces stored in the transaction library is performed using the distance function, and may return the following recorded request:

Message ID: 37

ProtocolOp: searchRequest
ObjectName: cn=Miao DU,ou=Administration,
   ou=Corporate,o=DEMOCORP,c=AU
Scope: 0 (baseObject)
   , which is paired with the following recorded response:

Message ID: 37

ProtocolOp: searchResEntry
ObjectName: cn=Miao DU,ou=Administration,
   ou=Corporate,o=DEMOCORP,c=AU
Scope: 0 (baseObject)

Message ID: 37

ProtocolOp: searchResDone
resultCode: success
   Symmetric field identification as described herein results in two substrings that are identical across request and response:

Message ID: 37

ProtocolOp:

and
ObjectName: cn=Miao DU,ou=Administration,
   ou=Corporate,o=DEMOCORP,c=AU
Scope: 0 (baseObject)
   By substituting the corresponding values from the incoming request, the following response is generating in accordance with some embodiments of the present disclosure:

Message ID: 18

ProtocolOp: searchResEntry
ObjectName: cn=Mal BAIL,ou=Administration,
   ou=Corporate,o=DEMOCORP,c=AU
Scope: 0 (baseObject)

Message ID: 18

ProtocolOp: searchResDone
resultCode: success

Accordingly, some embodiments of the present disclosure provide service emulation or virtualization methods that do not require explicit or pre-existing knowledge of the underlying structural information (which may indicate the protocol, operation type, and/or header information) of messages. Rather, such methods may generate responses indirectly or “opaquely” by using a received request and a distance function to find the closest matching request in a transaction library, and may then return the associated response from the transaction library, as modified with symmetric field substitution from the received request.

Opaque message matching in accordance with embodiments of the present disclosure thus allows a service or system to be virtualized without (or otherwise independent of) data explicitly indicating the service protocol message structure and/or service operation types. In particular embodiments, the Needleman-Wunsch sequence matching algorithm may be used to match message requests as a series of bytes for service virtualization, thereby requiring no knowledge of the message protocol or other structural information. Entropy-based weighting of message sections during distance calculation may also be used to increase accuracy in response generation. Furthermore, embodiments of the present disclosure may increase the efficiency of opaque message matching, by using clustering to organize the transaction library into groups of similar messages, thus reducing the number of transactions to be searched during the response generation process. As such, responses can be generated in real-time, even for large transaction libraries.

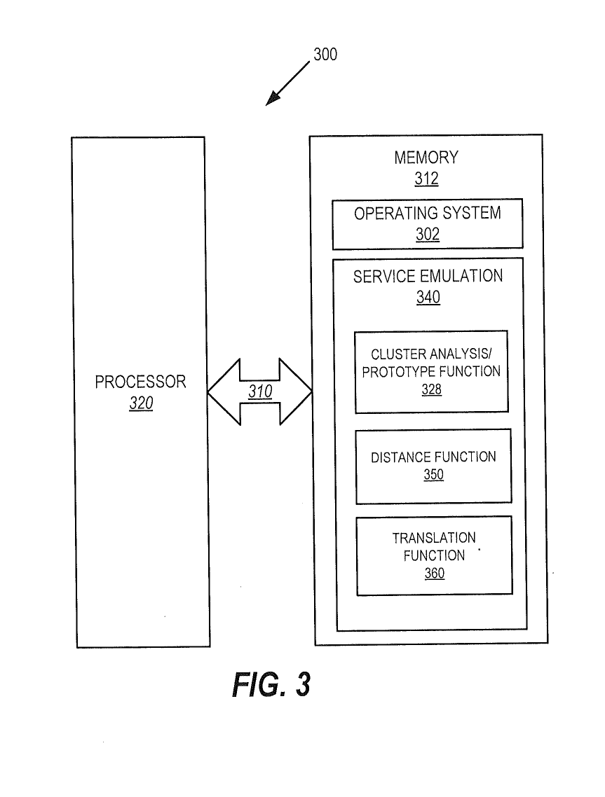

FIG. 3 illustrates a computing system or environment for opaque service emulation in accordance with further embodiments of the present disclosure. In particular, FIG. 3 illustrates a processor 320 and memory 312 that may be used in computing devices or other data processing systems, such as the computing device 200 of FIG. 2 and/or the virtual service environment 115 of FIG. 1. The processor 320 communicates with the memory 312 via an address/data bus 310. The processor 320 may be, for example, a commercially available or custom microprocessor, including, but not limited to, digital signal processor (DSP), field programmable gate array (FPGA), application specific integrated circuit (ASIC), and multi-core processors. The memory 312 may be a local storage medium representative of the one or more memory devices containing software and data in accordance with some embodiments of the present invention. The memory 312 may include, but is not limited to, the following types of devices: cache, ROM, PROM, EPROM, EEPROM, flash, SRAM, and DRAM.

As shown in FIG. 3, the memory 312 may contain multiple categories of software and/or data installed therein, including (but not limited to) an operating system block 302 and a service emulation block 340. The operating system 302 generally controls the operation of the computing device or data processing system. In particular, the operating system 302 may manage software and/or hardware resources and may coordinate execution of programs by the processor 320, for example, in providing the service emulation environment 115 of FIG. 1.

The service emulation block 340 is configured to carry out some or all of the functionality of the cluster analyzer 128, the request analyzer 150, and/or the response generator 160 of FIG. 1. In particular, the service emulation block 340 includes a cluster analysis/prototype function module 328, a distance function module 350, and a translation function module 360. Responsive to accessing a transaction library including a set of messages (including requests and associated responses) communicated between a client (such as the system under test 105 of FIG. 1) and a target service for virtualization (such as one or more of the endpoints 111A . . . 111N of the deployment environment 110 of FIG. 1), the cluster analysis/prototype function module 328 groups similar ones of the messages to partition the transaction library into “clusters” of similar messages. The similarity is determined using one or more distance measures or functions (such as the Needleman-Wunsch sequence alignment algorithm). The distance function may also be weighted according to different weightings assigned to respective sections of the messages stored in the transaction library, for example, based on the relative variability of characters in the message sections as an indicator of the information types contained therein.

The cluster analysis/prototype function module 328 further determines respective cluster prototypes for each of the message clusters. The cluster prototype functions as a representative for the group of similar message transactions of the corresponding message cluster. The cluster analysis/prototype function module 328 may select a sample transaction from the messages of the cluster (such as a centroid transaction) as the cluster prototype, or may generate the cluster prototype to include (or “summarize”) common patterns of the message transactions in the cluster. For example, in some embodiments the cluster analysis/prototype function module 328 may calculate relative distances between the messages of a particular cluster (for example, using sequence matching as described herein), and may select a representative one of the messages as the cluster prototype for that cluster based on the relative distances. For instance, the cluster analysis/prototype function module 328 may calculate the centroid transaction by identifying the message transaction having the lowest sum of the absolute distances to other message transactions in the cluster, the lowest sum of squared distances. Other methods for selecting a representative transaction for the cluster may also be used. Table 4a below illustrates an example centroid transaction prototype.

Alternatively, the cluster analysis/prototype function module 328 may identify one or more common features or commonalities among the message transactions of a cluster, and generate the cluster prototype to include the common features of the transactions in the cluster. For example, a cluster prototype may be generated to include a substring sequence that is common to two or more message transactions of the cluster. A substring sequence may be defined as a sequence of n or more bytes or characters, and substring sequences which occur in more than a predetermined percentage X of the message transactions in the cluster may be included in the common substring set, where the percentage X may be a configurable threshold. The relative positions in the requests and/or responses in which the common substring sequences occur may also be recorded. Table 4b below illustrates an example of calculating common substring sequences.

Also, a cluster prototype may be generated to include particular characters at particular sections thereof based on a frequency of such characters in respective positions of the message transactions of the cluster. For example, a frequency table may be generated to identify the characters or bytes which occur at each position in the message. To calculate the frequency table, messages in the cluster may be aligned, for example, using a fixed alignment, or a multiple sequence alignment algorithm (such as ClustalW). Table 4c below illustrates an example of calculating a frequency table.

In addition, a cluster prototype may be generated to represent a “consensus” transaction for the cluster. In particular, after completing a multiple sequence alignment, the consensus may be calculated by selecting, at each byte (or character) position, the most commonly occurring byte or character at that position, provided the byte/character has a relative frequency above a predetermined threshold. In other words, the cluster prototype may include a particular byte/character at a particular position when there is a consensus (among the message transactions of the cluster) as to the commonality of the byte at that position.) Positions for which there is no consensus may be left as a gap in the consensus transaction. Table 4d below illustrates an example of calculating a transaction consensus.

It will be understood that these and/or other operations of the cluster analysis/prototype function 328 may be performed as a pre-processing step, prior to any response generation. Also, the pre-processing message cluster generation operations performed by the cluster analysis/prototype function module 328 may utilize the same distance function utilized by the distance function module 350 in run-time response generation operations (as discussed below), or a different distance function may be used.

Still referring to FIG. 3, at run-time, the distance function module 350 compares an unknown, incoming message with the cluster prototype for each of the message clusters generated by the cluster analysis/prototype function 328, in order to determine the similarity of the message clusters relative to the incoming message. The message cluster corresponding to the cluster prototype having the minimum distance to the incoming request may be selected as the matching cluster. Thus, rather than comparing the incoming message to all of the messages in the transaction library, the distance function compares the incoming request only with the cluster prototypes, reducing the processing burden and allowing for increased speed and efficiency. As such, for an unknown request from a system under test, the most similar one of the message clusters can be identified and selected using the distance function.

As noted above, the distance function utilized by the distance function module 350 may be the same as or different than the distance function used by the cluster analysis/prototype function 328 during cluster generation. However the response generation distance function (used by the distance function module 350) may only compare the incoming request to the cluster prototype (as no response is available for comparison), while the cluster generation distance function (used by the by the cluster analysis/prototype function 328) may compare information from the stored requests and/or the responses. Also, the distance function utilized by the distance function module 350 may be weighted according to different weightings assigned to respective sections of the cluster prototypes, for example, based on the relative variability of respective character positions therein as an indicator of the information types contained in the sections.

After selecting the closest-matching message cluster to the incoming request, the distance function module 350 selects a particular message transaction from the identified message cluster. In some embodiments, the distance function module 350 may compare the unknown request with all of the individual message transactions (that is, each of the stored requests) in the identified message cluster (as sequences of bytes or characters). The distance function 350 may thereby select a closest-matching one of the stored requests in the identified message cluster based on subsequence or pattern matching, rather than (i.e., independent of) message structure information (which may indicate the protocol, operation type, and/or header information) of the incoming request. For example, the distance function module 350 may be configured to implement the Needleman-Wunsch global sequence alignment algorithm in measuring the similarity of the received request to each of the messages of the identified message cluster. However, other distance functions may also be used. Also, in some embodiments, the distance function 350 may simply select one of the requests in the identified message cluster (for example, a request corresponding to a centroid transaction), rather than comparing the incoming request to each individual request of the identified message cluster. Other criteria may also be used to select a particular message transaction from the identified message cluster.

The translation function module 360 performs response generation using the message transaction selected by the distance function module 350, for example, using symmetric field substitution. In particular, the translation function module 360 identifies symmetric fields (that is, matching character strings) between the request and response of the selected message transaction. Symmetric fields may refer to common subsequences, of a length greater than a given threshold, which occur in both the request and associated response of a selected message transaction. In some embodiments, shorter subsequences (which occur wholly within a longer common subsequence) may be ignored. For example, for the two character strings “Hello_World” and “Hello_Kitty”, “Hello_” is a common subsequence. The shorter subsequence matches occurring within “Hello_” (such as “Hell”, “llo_”, “ello”, etc.) may be ignored when substituting fields from a matching request/response pair to generate the response to the incoming request from the system under test. The translation function module 360 may thereby generate the response independent of receiving data or other knowledge indicating structural information (including the protocol, operation type, and/or header information) of the incoming request, by substituting the symmetric fields from a response associated with the selected one of the requests from the identified message cluster.

Although FIG. 3 illustrates example hardware/software architectures that may be used in a device, such as the computing device 200 of FIG. 2, to provide opaque service emulation in accordance with some embodiments described herein, it will be understood that the present invention is not limited to such a configuration but is intended to encompass any configuration capable of carrying out operations described herein. Moreover, the functionality of the computing device 200 of FIG. 2 and the hardware/software architecture of FIG. 3 may be implemented as a single processor system, a multi-processor system, a processing system with one or more cores, a distributed processing system, or even a network of stand-alone computer systems, in accordance with various embodiments.

Computer program code for carrying out the operations described above and/or illustrated in FIGS. 1=3 may be written in a high-level programming language, such as COBOL, Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

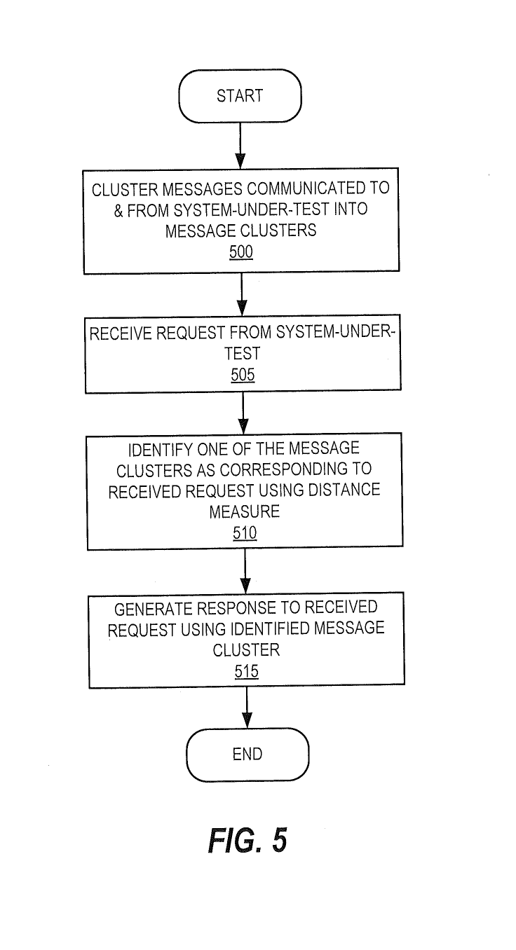

Operations for providing opaque service emulation in accordance with some embodiments of the present disclosure will now be described with reference to the flowcharts of FIGS. 5 and 6. FIGS. 5 and 6 illustrate operations that may be performed by a virtual service environment (such as the environment 115 of FIG. 1) to emulate the behavior of a target system for virtualization (such as the environment 110 of FIG. 1) in response to a request from the system under test (such as the system under test 105 of FIG. 1).

Referring now to FIG. 5, operations begin at block 500 where messages (including requests and associated responses) that have been previously communicated with (i.e., to and/or from) the system under test are clustered or otherwise grouped into message clusters. For example, the messages may be stored in a transaction library, and the transaction library may be partitioned based on relative similarities among the messages to define message clusters including similar ones of the stored messages. The relative similarities of the stored messages may be calculated using a distance function or measure, such as the Needleman-Wunsch sequence alignment algorithm. For example, the distance function may be applied based on request similarity, response similarity, or a combination of request and response similarities. In some embodiments, the distance function may weight different parts of the messages differently. For example, different weightings may be assigned to respective sections of the messages based on a relative variability thereof as an indicator of respective information types contained therein.

Still referring to FIG. 5, at block 505, a request is received from the system under test. The request may be transmitted from the system under test to request a service on which the system under test depends, such as that provided by one or more of the endpoints 111A-111N of the deployment environment 110 of FIG. 1. For example, the received request may be in the form of an LDAP or a SOAP message. At block 510, one of the message clusters is identified as corresponding to the received request using a distance function or measure. For example, a representative message (referred to herein as a cluster prototype) may be selected or generated for each of the message clusters in a pre-processing step, a similarity of the received request to each of the cluster prototypes may be determined using the distance function, and one of the message clusters corresponding to the closest-matching one of the cluster prototypes may be identified. The cluster identification at block 510 may be performed independently of a similarity of the received request to all of the individual messages of each message cluster; that is, the incoming request may be compared only to the cluster prototypes, rather than to each message in a cluster, to identify one of the message clusters.

The distance function used in cluster identification at block 510 may be the same as or different than the distance function used in cluster generation at block 500, and may be independent of a message structure (which may indicate protocol, operation type, and/or header information) of the received request, such that a closest matching one of the cluster prototypes may be indirectly identified based on similarity, rather than based on the contents thereof. In some embodiments, this distance function used cluster identification at block 510 may also be entropy-weighted as discussed above, such that different weightings may be assigned to respective sections of the cluster prototypes based on a relative variability of character positions therein as an indicator of respective information types contained therein.

Using the identified one of the stored message clusters, a response to the received request is generated at block 515. For example, a particular message from the identified message cluster may be selected (for example, a center message or a closest-matching message from the identified message cluster), and the response may be generated therefrom using common subsequence identification and/or symmetric field substitution as described herein.

FIG. 6 illustrates operations for providing opaque service emulation in accordance with some embodiments of the present disclosure in greater detail. Referring now to FIG. 6, operations begin at block 600 by monitoring communication messages (including request/response pairs; also referred to as “message transactions”) exchanged between a system under test and one or more endpoints, and storing the request/response pairs in a transaction library. The endpoint(s) may correspond to a system upon which the system under test depends (that is, where the system under test is a client), such as the endpoints 111A-111N of the deployment environment 110 of FIG. 1. The request/response pairs stored in the transaction library are used as historical data for generating a response to an incoming request from a system under test, by matching the incoming request to one of the stored requests, and generating the response based on a stored response associated with the matching one of stored requests. Embodiments of the present invention further improve such message matching by using clustering to group or organize the transaction library, thereby reducing the search and matching burden and increasing efficiency.

In particular, the request/response pairs stored in the transaction library are pre-processed at block 605 to group similar ones of the request/response pairs into respective message clusters using a first distance function (also referred to herein as a clustering distance measure). For example, relative distances between respective requests and responses may be calculated based on the clustering distance measure, and the transaction library may be partitioned based on the relative distances such that the message clusters include requests and responses having similar relative distances. A data clustering method or algorithm (such as VAT), BEA, K-Means, a hierarchical clustering algorithm, etc.) may be used to group messages/transactions into clusters of similar messages. For instance, a distance matrix may be generated to include the relative distances for the respective requests and responses, and the clustering algorithm may be applied to the distance matrix to group the requests and responses having similar relative distances into the message clusters. The clustering algorithm may be fully automated, or may include some human supervision (such as in VAT).

At block 609, a cluster prototype is generated or otherwise determined for each message cluster. The cluster prototype for a message cluster may be a sample request/response selected from that message cluster (such as the centroid transaction), or may be a “summary” that is generated by identifying one or more commonalties among the requests/responses of the cluster and including the one or more commonalities in the cluster prototype. The commonalities may be identified based on common substring(s), frequencies of characters, and/or commonalities of characters at particular message positions. Each message cluster thereby includes a corresponding cluster prototype that represents the messages thereof.

At block 610, an unknown request Reqᵢₙ is received from a system under test. The unknown request Reqᵢₙ may be directed to an endpoint and/or environment for which service emulation is desired, such as the deployment environment 110 of FIG. 1. Responsive to receiving the unknown request Reqᵢₙ, a similarity of the unknown request Reqᵢₙ to the cluster prototype for each of the message clusters is calculated at block 615 using a second distance function. For example, the second distance function may be used to compare the sequence of bytes or characters of the unknown request Reqᵢₙ to each of the cluster prototypes, and to determine a similarity thereto based on a byte-by-byte or character-by-character comparison. The second distance function may be the same as or different than the first distance function. For example, the Needleman-Wunsch function may be used as the second distance function; however, embodiments of the present disclosure are not limited thereto.

At block 620, a message cluster that most closely corresponds to or matches the unknown request Reqᵢₙ is indirectly identified based on the calculated distance of the corresponding cluster prototype (rather than based on knowledge of the contents thereof). The identification is performed based on the similarity calculated at block 615, and independent of knowledge of a message structure and/or protocol of the unknown request Reqᵢₙ. In some embodiments, a maximum distance threshold may be used such that, if no message clusters are identified as having a distance to the unknown request Reqᵢₙ less than the maximum distance threshold, then a default response (such as an error message) may be generated and transmitted to the system under test.

Responsive to identifying one of the message clusters at block 620, a request Reqₛᵢₘ is selected for the identified message cluster at block 624. For example, the request Reqₛᵢₘ may be a request corresponding to a centroid one of the messages in the identified cluster, or may be a closest-matching one of the requests in the identified cluster. One or more symmetric fields between the request Reqₛᵢₘ and its associated paired response Resₛᵢₘ are identified at block 625. For example, the symmetric field(s) may be identified by recording position indices of each symmetric field within Reqₛᵢₘ and Resₛᵢₘ. In some embodiments, the same matching string may occur multiple times within Reqₛᵢₘ and/or Resₛᵢₘ, and the position of each instance may be recorded.

At block 630, symmetric field substitution is performed to modify the paired response Resₛᵢₘ with the symmetric information from the unknown request Reqᵢₙ, to generate a response Resₒᵤₜ to the system under test. For example, as noted above, a sequence alignment algorithm such as Needleman-Wunsch may be used to align Reqₛᵢₘ and Reqᵢₙ based on byte index or character position. For each symmetric field identified at block 625, the position indices may be updated to compensate for any gaps which may have been inserted during alignment of Reqₛᵢₘ and Reqᵢₙ, resulting in modified positions. If gaps are inserted within the symmetric field, then the length of the symmetric field may also be modified, resulting in a modified length, and the match string may likewise be modified to contain the aligned bytes or characters in the symmetric field position for Reqᵢₙ, resulting in a modified string. For each of the symmetric fields, the matching subsequence may be copied from the unknown request Reqᵢₙ to create the new response Resₒᵤₜ by overwriting the characters or bytes at the corresponding positions in the response Resₛᵢₘ If the modified length is different to the original symmetric field length, then extra bytes (or characters) may be inserted or deleted into the response Resₒᵤₜ at the symmetric field positions, to compensate. As such, a response Resₒᵤₜ to the unknown request Reqᵢₙ may be generated based on the response Resₛᵢₘ associated with the request Reqₛᵢₘ selected from the message cluster that was identified as corresponding to the unknown request Reqᵢₙ. The generated response Resₒᵤₜ is then transmitted to the system under test at block 635.

Embodiments of the present disclosure will now be described with reference to the following example, illustrating the generation of a response to an unknown request. Table 1 below illustrates an example message transaction library, such as the libraries 130, 230 discussed above:

TABLE 1
Example Message Transaction Library

| # | Request | Response |
|---|---|---|
| 1 | {Id:1,Msg:SearchRq, | {Id:1,Msg:SearchRsp,Result: |
| | Lastname:Du} | Ok,Firstname:Miao, Lastname: |
| | | Du,Telephone:12345678} |
| 2 | {Id:2,Msg:SearchRq, | {Id:2,Msg:SearchRsp,Result: |
| | Lastname:Versteeg} | Ok,Firstname:Steve,Lastname: |
| | | Versteeg,Telephone:11111111} |
| 3 | {Id:3,Msg:AddRq, | {Id:3,Msg:AddRsp,Result:Ok} |
| | Lastname:Schneider, | |
| | Firstname:Jean- | |
| | Guy,Telephone:123456} | |
| 4 | {Id:4,Msg:SearchRq, | {Id:4,Msg:SearchRsp,Result: |
| | Lastname:Han} | Ok,Firstname:Jun,Lastname:Han, |
| | | Telephone:33333333} |
| 5 | {Id:5,Msg:SearchRq, | {Id:5,Msg:SearchRsp,Result:Ok, |
| | Lastname:Grundy} | Firstname:John,Lastname:Han, |
| | | Telephone:44444444} |
| 6 | {Id:6,Msg:AddRq, | {Id:6,Msg:AddRsp,Result:Ok} |
| | Lastname:Hine,Firstname:Cam, | |
| | Telephone:555555} | |

In the present example, after applying a clustering algorithm, the messages are grouped into two clusters as shown in Tables 2 and 3:

TABLE 2
Example Cluster 1

| # | Request | Response |
|---|---|---|
| 1 | {Id:1,Msg:SearchRq, | {Id:1,Msg:SearchRsp,Result: |
| | | Lastname:Du}Ok,Firstname:Miao,Lastname: |
| | | Du,Telephone:12345678} |
| 2 | {Id:2,Msg:SearchRq, | {Id:2,Msg:SearchRsp,Result: |
| | Lastname:Versteeg} | Ok,Firstname:Steve,Lastname: |
| | | Versteeg, |
| | | Telephone:11111111} |
| 4 | {Id:4,Msg:SearchRq, | {Id:4,Msg:SearchRsp,Result: |
| | Lastname:Han} | Ok,Firstname:Jun,Lastname:Han, |
| | | Telephone:33333333} |
| 5 | {Id:5,Msg:SearchRq, | {Id:5,Msg:SearchRsp,Result: |
| | Lastname:Grundy} | Ok,Firstname:John,Lastname: |
| | | Han,Telephone:44444444} |

TABLE 3
Example Cluster 2

| # | Request | Response |
|---|---|---|
| 3 | {Id:3,Msg:AddRq,Lastname:Schneider, | {Id:3,Msg:AddRsp, |
| | Firstname:Jean- | Result:Ok} |
| | Guy,Telephone:123456} | |
| 6 | {Id:6,Msg:AddRq,Lastname:Hine,First | {Id:6,Msg:AddRsp, |
| | name:Cam,Telephone:555555} | Result:Ok} |

A cluster prototype can be generated or otherwise selected for each cluster using several methods. For example, the centroid transaction prototype for cluster 1 may be:

TABLE 4a
Example Centroid Transaction Prototype

| | | |
|---|---|---|
| 1 | {Id:1,Msg:SearchRq,Lastname:Du} | {Id:1,Msg:SearchRsp,Result: |
| | | Ok,Firstname:Miao,Lastname: |
| | | Du,Telephone:12345678} |

The list of common substrings for the prototype of cluster 1 may be:

TABLE 4b
Example Common substring prototype

{Id:
,Msg:SearchRq,Lastname:

Also, a frequency table for cluster 1 may be calculated using multiple sequence alignment, which may yield the following (using ClustalW):

### {Id:1,Msg:SearchRq,Lastname:------Du}

### {Id:4,Msg:SearchRq,Lastname:-----Han}

### {Id:2,Msg:SearchRq,Lastname:Versteeg}

### {Id:5,Msg:SearchRq,Lastname:G-rundy-}

Counting the frequencies of different byte values at each byte position yields the following frequency table:

TABLE 4c
Example Frequency table prototype

| { | 4 | | | | | | | | | | | | | | | | | |
|---|---|---|---|---|---|---|---|---|---|---|---|---|---|---|---|---|---|---|
| } | | | | | | | | | | | | | | | | | | |
| : | | | | 4 | | | | | | 4 | | | | | | | | |
| , | | | | | | 4 | | | | | | | | | | | | |
| 1 | | | | | 1 | | | | | | | | | | | | | |
| 2 | | | | | 1 | | | | | | | | | | | | | |
| 4 | | | | | 1 | | | | | | | | | | | | | |
| 5 | | | | | 1 | | | | | | | | | | | | | |
| D | | | | | | | | | | | | | | | | | | |
| G | | | | | | | | | | | | | | | | | | |
| H | | | | | | | | | | | | | | | | | | |
| I | | 4 | | | | | | | | | | | | | | | | |
| L | | | | | | | | | | | | | | | | | | |
| M | | | | | | | 4 | | | | | | | | | | | |
| R | | | | | | | | | | | | | | | | | 4 | |
| S | | | | | | | | | | | 4 | | | | | | | |
| V | | | | | | | | | | | | | | | | | | |
| a | | | | | | | | | | | | | 4 | | | | | |
| c | | | | | | | | | | | | | | | 4 | | | |
| d | | | 4 | | | | | | | | | | | | | | | |
| e | | | | | | | | | | | | 4 | | | | | | |
| g | | | | | | | | | 4 | | | | | | | | | |
| h | | | | | | | | | | | | | | | | 4 | | |
| m | | | | | | | | | | | | | | | | | | |
| n | | | | | | | | | | | | | | | | | | |
| q | | | | | | | | | | | | | | | | | | 4 |
| r | | | | | | | | | | | | | | 4 | | | | |
| s | | | | | | | | 4 | | | | | | | | | | |
| t | | | | | | | | | | | | | | | | | | |
| u | | | | | | | | | | | | | | | | | | |
| y | | | | | | | | | | | | | | | | | | |
| — | | | | | | | | | | | | | | | | | | |
| { | | | | | | | | | | | | | | | | | | |
| } | | | | | | | | | | | | | | | | | | 4 |
| : | | | | | | | | | | 4 | | | | | | | | |
| , | 4 | | | | | | | | | | | | | | | | | |
| 1 | | | | | | | | | | | | | | | | | | |
| 2 | | | | | | | | | | | | | | | | | | |
| 4 | | | | | | | | | | | | | | | | | | |
| 5 | | | | | | | | | | | | | | | | | | |
| D | | | | | | | | | | | | | | | | | 1 | |
| G | | | | | | | | | | | 1 | | | | | | | |
| H | | | | | | | | | | | | | | | | 1 | | |
| I | | | | | | | | | | | | | | | | | | |
| L | | 4 | | | | | | | | | | | | | | | | |
| M | | | | | | | | | | | | | | | | | | |
| R | | | | | | | | | | | | | | | | | | |
| S | | | | | | | | | | | | | | | | | | |
| V | | | | | | | | | | | 1 | | | | | | | |
| a | | | 4 | | | | 4 | | | | | | | | | | 1 | |
| c | | | | | | | | | | | | | | | | | | |
| d | | | | | | | | | | | | | | | | 1 | | |
| e | | | | | | | | | 4 | | | 1 | | | | 1 | 1 | |
| g | | | | | | | | | | | | | | | | | | 1 |
| h | | | | | | | | | | | | | | | | | | |
| m | | | | | | | | 4 | | | | | | | | | | |
| n | | | | | | 4 | | | | | | | | | 1 | | | 1 |
| q | | | | | | | | | | | | | | | | | | |
| r | | | | | | | | | | | | | 2 | | | | | |
| s | | | | 4 | | | | | | | | | | 1 | | | | |
| t | | | | | 4 | | | | | | | | | | 1 | | | |
| u | | | | | | | | | | | | | | 1 | | | | |
| y | | | | | | | | | | | | | | | | | 1 | |
| — | | | | | | | | | | | 2 | 3 | 2 | 2 | 2 | 1 | | 1 |

Using the same multiple sequence alignment as with the frequency table prototype, the consensus prototype may be (using a threshold of 0.5):

TABLE 4d
Example Consensus sequence prototype

{Id:-,Msg:SearchRq,Lastname:--r-----}

Thus, embodiments of the present disclosure provide a system that is configured to automatically build executable interactive models of software service behavior from recorded message transactions, without prior knowledge of the internals of the service and/or of the protocols the service uses to communicate, which can reduce human effort in manually specifying models, as well as reduce reliance on system experts and/or the need for extensive documentation of the service protocol and behavior. Models may be built directly from interaction traces previously recorded between a system under test and a software service upon which the system under test depends, by using the interaction traces as a library with which to compare new, unknown requests received from a system under test. A distance function, such as the Needleman-Wunsch longest common subsequence alignment method, may be used to calculate the distances/similarities between an unknown request from a system under test and the recorded message transactions. In some embodiments, the response associated with the closest matching request is identified as the most relevant response to use in synthesis of a response to a system under test, where symmetric field substitution is used to modify the identified response so that it is tailored to the unknown request.

Further embodiments are directed to an extension of opaque response matching for service emulation/virtualization, based on realization that some fields in the incoming request (such as the operation name) are more relevant in identifying a stored request/response for generation of a response to the system under test. Still further embodiments may use clustering to group responses and requests, and then infer relevant or critical junctures at which different types of responses are sent for similar looking requests. Utilizing conversation state information may also improve the accuracy of synthesized responses.

As such, embodiments of the present disclosure may allow for (semi-) automatic identification of which part(s) of a request message most likely correspond to a service operation name, use of this information to divide the set of interaction traces into clusters containing a single operation type only, and restriction of the search for the most similar request to one cluster only. Such an approach should also improve run-time performance.

Specific examples discussed below provide results of the use of two clustering algorithms (BEA and VAT) and the Needleman-Wunsch longest common subsequence distance measure combined with symmetric field substitution in opaque response generation for two message protocols. In particular, for evaluation purposes, two protocols were used where the precise message structures (as well as the corresponding temporal properties) are known: the Simple Object Access Protocol (SOAP) and the Lightweight Directory Access Protocol (LDAP). SOAP is a light-weight protocol designed for exchanging structured information typically in a decentralized, distributed environments, whereas LDAP may be widely used in large enterprises for maintaining and managing directory information. The interaction trace for SOAP used for evaluation was generated based on a recording of a banking example using the LISA® tool. The protocol included 7 different request types, each with a varying number of parameters, encoding typical transactions from a banking service. From a predefined set of account identifiers, account names, etc., an interaction trace containing 1,000 request/response pairs was generated. Amongst those, there were 548 unique requests (with 25 requests occurring multiple times), 714 unique responses (the replicated ones predominantly due to the fact that the deleteToken-Response message only had true or false as possible return values), and 22 duplicated request/response pairs. For purposes of evaluation, this was considered a sufficiently diverse population of messages to work with.

The following is one of the recorded requests:

```
<?xml version=“1.0”?>
    <S:Envelope
    xmlns:S=“http://schemas.xmlsoap.org/soap/envelope/”>
    <S:Body>
        <ns2:getAccount xmlns:ns2=“http://bank/”>
        <accountId>867-957-31</accountId></ns2:getAccount>
    </S:Body>
</S:Envelope>
```

with the following the corresponding response:

```
<?xml version=“1.0”?>
    <S:Envelope
    xmlns:S=“http://schemas.xmlsoap.org/soap/envelope/”>
    <S:Body>
        <ns2:getAccountResponse xmlns:ns2=“http://bank/”>
        <return>
        <accountId>867-957-31</accountId>
        <fname>Steve</fname>
        <lname>Hine</lname>
    </return>
    </ns2:getAccountResponse>
    </S:Body>
</S:Envelope>
```

This example illustrates that, besides the structural SOAP information encoded in both messages, there may be specific information that appears in both the SOAP request and SOAP response, such as the account-ID in the example above. LDAP is a binary protocol that uses an ASN.1 encoding to encode and decode text-based message information to and from its binary representation, respectively. A corresponding decoder was used in order to translate recorded LDAP messages into a text format and an encoder was used to check whether the synthesized responses were well-formed.

The LDAP interaction trace used for the evaluation included 1000 unique interactions containing some core LDAP operations, such as adding, searching, modifying etc. applied a sample directory. The trace did not contain duplicated requests or responses, and the search responses contained a varying number of matching entries, ranging from zero to 12.

The following briefly illustrates the textual representation of a search request:

Message ID: 15

ProtocolOp: searchRequest
ObjectName: cn=Juliet LEVY,ou=Administration,
   ou=Corporate,o=DEMOCORP,c=AU
Scope: 0 (baseObject)
   , and the associated response, including the merge of a search result entry and a search result done message:

Message ID: 15

ProtocolOp: searchResEntry
ObjectName: cn=Juliet LEVY,ou=Administration,
   ou=Corporate,o=DEMOCORP,c=AU
Scope: 0 (baseObject)

Message ID: 15

ProtocolOp: searchResDone
resultCode: success
   This example LDAP request contains a (unique) message identifier (Message ID: 15) and a specific object name (ObjectName: . . . ) as the root node for the search to be used. The associated responses use the same message identifier (to indicate the request they are in response to) and the searchResEntry message refers to the same object name as the request. To synthesize correct LDAP responses, the corresponding information can be copied across from the incoming request to the most similar response to be modified.

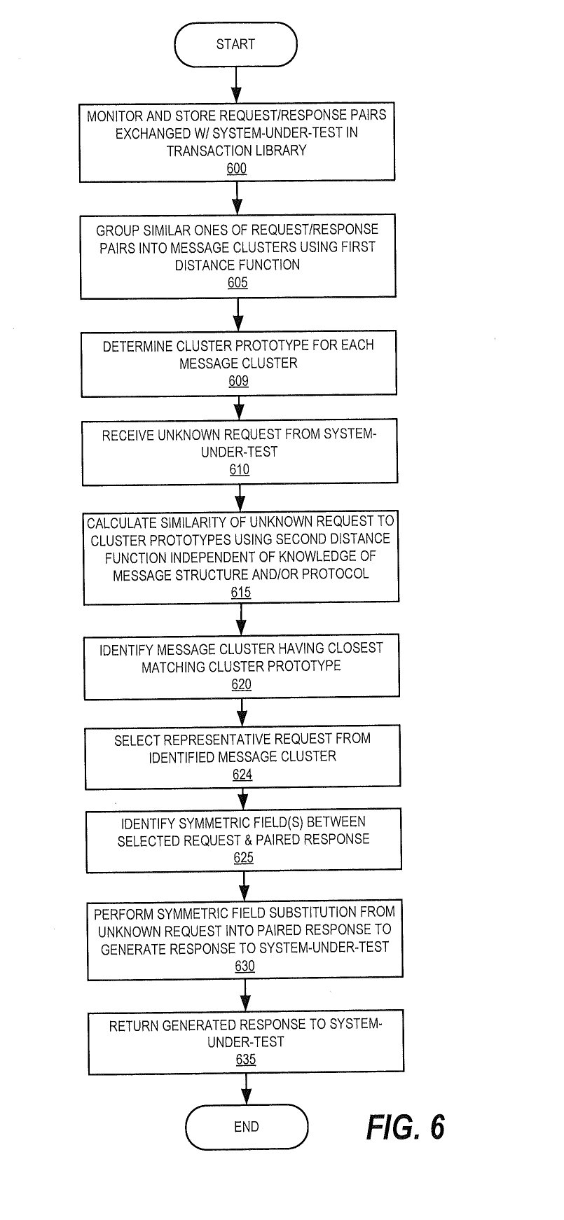

A cross-validation approach is one method for assessing how the results of a statistical analysis may be generalized to an independent data set. For evaluation purposes, a 10-fold cross-validation approach was used for the recorded SOAP messages and the recorded LDAP messages. As shown in FIG. 7, a recorded data set 730 was randomly partitioned into 10 groups 735. Of the 10 groups, Group i 735i is considered to be the evaluation group, and the remaining 9 groups define the training set. The cross-validation process was repeated 10 times (the same as the number of groups), so that each of the 10 groups 730 was used as the evaluation group 735i once. For each message in the evaluation group 735i, the resulting response generated by the emulator 715 was compared with the associated recorded response. Both the effectiveness and the efficiency of the response synthesis were investigated. The following criteria were used to evaluate the effectiveness of synthesized responses:
1. Identical: the synthesized response is identical to the recorded response if all characters in the synthesized response exactly match those in the recorded response.
2. Protocol Conformant: the synthesized responses are well-formed and also conform to the temporal interaction properties of the given protocol, i.e., the temporal consistency between request and response is preserved.
3. Well-Formed: the synthesized responses correspond to the structure required for responses as defined by the underlying protocol.
4. Ill-Formed: synthesized responses that do not meet the above criteria.

For the efficiency investigation, for each message in the evaluation Group I 735i, the amount of time taken to synthesize a response for an incoming request was recorded. Also, a weaker notion of “protocol conformant” was used, as the order in which the requests are selected from the evaluation set is random and, as a consequence, unlikely to conform to the temporal sequence of request-response pairs.

For purposes of evaluation, a “whole-interaction-trace-based” approach (as described in commonly-owned U.S. patent application Ser. No. 14/223,607 entitled “MESSAGE MATCHING FOR OPAQUE SERVICE VIRTUALIZATION,” the disclosure of which is incorporated by reference herein), referred to as the “No-Cluster” method, was used to benchmark both the effectiveness and efficiency of the cluster-based approach for synthesizing responses according to embodiments of the present disclosure. In particular, in the pre-processing stage, the BEA clustering algorithm and VAT clustering algorithm were applied to cluster interactions; and then, at the runtime stage, the Centre Only method and Whole Cluster method described above were used to synthesize responses.

In comparing the different outcomes achieved with the No Cluster method and cluster-based approaches for SOAP, neither the Centre Only method nor the Whole Cluster method appeared to generate ill-formed SOAP responses, and thus, produced the same outcomes as using the No Cluster method. This shows that for the SOAP case study used, the cluster-based approach had the same effectiveness as the No Cluster method in synthesizing accurate responses.

In addition, regardless of the method used to generate a response (i.e., either the No Cluster method or cluster-based methods), more time was consumed to synthesize responses for longer incoming requests. However, an improvement of the generation time was observed by using cluster-based approaches. Specifically, response generation time of using Whole Cluster methods was found to be at least 5 times quicker than using the No Cluster method; using Centre Only was able to further accelerate response message synthesis by approximately 120 times than when using the No Cluster method. Furthermore, although there was found to be more fluctuation in the response generation time when using the BEA algorithm to cluster messages, the selection of clustering approaches did not appear to significantly impact the response generation time. Based on these observations for the SOAP protocol, the Centre Only method was able to provide a good response message synthesis.

In comparing the different outcomes achieved with the No Cluster method and cluster-based approaches for LDAP, for the No Cluster method, 451 (out of 1,000) generated response messages were identical to the corresponding recorded responses (45.1%), and an additional 457 of the generated responses met the protocol conformant criterion (45.7%). Therefore, a total of 908 (or 90.8%) of all generated responses were considered to be valid. In contrast, the cluster-based approaches generated less valid responses, the number of which decrease by 14.7% to around 761 (out of 1000). By observing valid responses of cluster-based approaches, it was determined that the VAT algorithm offered better performance than the BEA algorithm. However, there was no distinguishable difference between results of the Centre Only method and the Whole Cluster method.

For both protocols, response generation time increased with the length of incoming requests. As the length of the majority of the LDAP incoming requests was shorter than the SOAP incoming requests, the LDAP response generation time was shorter than SOAP response generation time. Specifically, compared with the average response generation time of using No Cluster method (about 53.28 ms), using the Whole Cluster method produced responses about 9 times faster (about 5.46 ms), while using the Centre Only method further improved the generation time to around 0.79 ms. The response generation time when using the Whole cluster method fluctuated significantly, because the sizes of the respective clusters generated by the clustering algorithms were different. Therefore, the amount of time required to generate responses (when using the Whole Cluster method) varies with the size of the particular cluster. In contrast, as the number of clusters is stable, the response generation time when using the Centre Only method was observed to have only a slight fluctuation.

Based on the SOAP and LDAP experimental results, the cluster-based approach was able to generate valid responses more efficiently than searching the entire transaction library, illustrating that that the time cost of generating responses can be significantly reduced by reducing the number of distance calculations. However, as illustrated in the results for LDAP, the cluster-based approaches generated fewer valid responses. This can be attributed to differences between the SOAP and LDAP protocols. Most application-level protocols define message structures containing some form of operation or service name in their request, followed by a payload containing the data upon which the service is expected to operate. In LDAP, some messages may contain significantly more payload information than operation information; thus, two LDAP messages of different operation types, but with a similar payload, may be found to be the closest matching messages. In such a case, a response of the wrong operation type may be sent back, resulting in an invalid response.

According to embodiments of the present disclosure, data mining techniques may be used for opaque response generation in a large enterprise software emulation environment, and may be improved by clustering previously recorded interaction traces in a pre-processing stage. The clustered results may facilitate the mimicking of software interaction behaviors in the run-time stage, in particular, by reducing the number of distance calculations to be performed. As embodiments of the present disclosure do not require explicit knowledge of the protocols used by the target software components to communicate, the human effort of manually specifying interaction models may be eliminated. Moreover, by utilizing data mining techniques, the efficiency of response generation in the emulation environment may be greatly improved. Experimental results conducted on LDAP and SOAP protocols demonstrated that the response generation time can be reduced by 99% on average compared to non-clustering approaches, while the accuracy of response generation (the valid response rate) was 100% for SOAP and 75% for LDAP.

Further embodiments may omit the format transformation operations in building diverse interaction models. Improved cluster center selection methods may also be used to automatically summarize common characters among one or more messages within a cluster, which can be further used for synthesizing representative cluster centers. Also, multiple sequence alignment algorithms and/or hierarchical clustering may be used to group responses/requests into trees, which can help to infer the most common characters among requests/responses. The Needleman-Wunsch algorithm, which has relatively high time complexity, was used for the edit distance calculation for evaluation purposes; however, the efficiency of distance calculations may be improved by using parallel processing and using an approximation of the Needleman-Wunsch edit distance. Embodiments of the present invention may also be tested on larger trace collections and/or on a wider range of protocols, for example, proprietary protocols on legacy mainframe systems, which are often poorly documented.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of any means or step plus function elements in the claims below are intended to include any disclosed structure, material, or act for performing the function in combination with other claimed elements as specifically claimed.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method of service emulation, the method comprising:
clustering ones of a plurality of messages communicated between a system under test and a target system for emulation into message clusters;
receiving a request from the system under test;
identifying one of the message clusters as corresponding to the request based on a distance measure; and
generating a response to the request using the one of the message clusters that was identified,
wherein the clustering, the receiving, the identifying, and the generating comprise operations performed by a processor.

2. The method of claim 1, wherein the distance measure is independent of a message structure of the request, and wherein the identifying the one of the message clusters is performed without calculating respective similarities of the request to the ones of the messages thereof.

3. The method of claim 1, further comprising:
determining respective cluster prototypes for the message clusters,
wherein the identifying comprises:
calculating a similarity of the request to the respective cluster prototypes based on the distance measure; and
identifying the one of the message clusters as corresponding to the received request based on the similarity of the received request to a corresponding one of the cluster prototypes.

4. The method of claim 3, wherein the determining the respective cluster prototypes comprises, for the respective message clusters:
calculating relative distances between the ones of the messages thereof based on sequence matching; and
selecting a representative message among the ones of the messages thereof as a cluster prototype therefor based on the relative distances.

5. The method of claim 3, wherein the determining the respective cluster prototypes comprises, for the respective message clusters:
identifying a respective commonality among the ones of the messages thereof; and
generating a cluster prototype therefor to include the respective commonality.

6. The method of claim 5, wherein, for the respective message clusters, the respective commonality comprises a substring sequence that is common to ones of the messages thereof.

7. The method of claim 5, wherein, for the respective message clusters, the respective commonality is based on a frequency of characters at respective positions in the ones of the messages thereof.

8. The method of claim 5, wherein, for the respective message clusters, the respective commonality comprises a common character at a particular position in the ones of the messages thereof.

9. The method of claim 3, further comprising:
identifying respective sections of the cluster prototypes as containing respective information types based on a relative variability of respective character positions therein; and
assigning different weightings to the respective sections of the cluster prototypes according to the respective information types contained therein,
wherein the distance measure is weighted according to the different weightings assigned to the respective sections of the cluster prototypes.

10. The method of claim 3, wherein the distance measure comprises an edit distance, and wherein calculating the similarity comprises:
comparing a sequence of characters in the request with a sequence of characters in the respective cluster prototypes;
aligning the received request with ones of the respective cluster prototypes based on a subsequence that is common to the sequence of characters thereof; and
computing respective edit distances between the sequence of characters of the request and the sequence of characters of the ones of the respective cluster prototypes based on the aligning.

11. The method of claim 1, wherein the ones of the messages of the message clusters comprise respective requests and responses associated therewith communicated between the system under test and the target system, and wherein generating the response comprises:
selecting one of the respective requests of the one of the message clusters that was identified;
identifying respective fields in the one of the respective requests and in one of the responses associated therewith as comprising a common subsequence; and
populating a field in the one of the responses with a subsequence from the received request based on the respective fields that were identified.

12. The method of claim 1, wherein the messages are stored in a transaction library and comprise respective requests and responses thereto communicated between the system under test and the target system, wherein the clustering comprises:
calculating relative distances between the respective requests and responses thereto based on a clustering distance measure; and
partitioning the transaction library based on the relative distances such that the message clusters respectively comprise ones of the respective requests and responses thereto having similar relative distances.

13. The method of claim 12, wherein the clustering distance measure is weighted according to different weightings assigned to respective sections of the messages based on a relative variability thereof as an indicator of respective information types contained therein, and wherein the message clusters respectively comprise the ones of the messages having similar information types.

14. A computer system, comprising:
a processor; and
a memory coupled to the processor, the memory comprising computer readable program code embodied therein that, when executed by the processor, causes the processor to:
cluster ones of a plurality of messages communicated between a system under test and a target system for emulation into message clusters;
identify one of the message clusters as corresponding to a received request from the system under test based on a distance measure; and
generate a response to the request using the one of the message clusters that was identified.

15. The computer system of claim 14, wherein the distance measure is independent of a message structure of the request, and wherein the computer readable program code causes the processor to identify the one of the message clusters without calculating respective similarities of the received request to the ones of the messages thereof.

16. The computer system of claim 14, wherein the computer readable program code further causes the processor to:
determine respective cluster prototypes for the message clusters;
calculate a similarity of the received request to the respective cluster prototypes based on the sequence matching; and
identify the one of the message clusters as corresponding to the received request based on the similarity of the received request to a corresponding one of the cluster prototypes.

17. The computer system of claim 16, wherein, to determine the respective cluster prototypes, the computer readable program code further causes the processor to, for the respective message clusters:
calculate relative distances for the ones of the messages thereof based on sequence matching; and
select a representative message among the ones of the messages thereof as a cluster prototype therefor based on the relative distances.

18. The computer system of claim 16, wherein, to determine the respective cluster prototypes, the computer readable program code further causes the processor to, for the respective message clusters:
identify a respective commonality among the ones of the messages thereof; and
generate a cluster prototype therefor to include the respective commonality.

19. The computer system of claim 16, wherein the computer readable program code further causes the processor to:
identify respective sections of the cluster prototypes as containing respective information types based on a relative variability of respective character positions therein; and
assign different weightings to the respective sections of the cluster prototypes according to the respective information types contained therein,
wherein the distance measure is weighted according to the different weightings assigned to the respective sections of the cluster prototypes.

20. A computer program product comprising:
a computer readable storage medium having computer readable program code embodied in the medium, the computer readable program code comprising:
computer readable code to cluster ones of a plurality of messages communicated between a system under test and a target system for emulation into message clusters;
computer readable code to identify one of the message clusters as corresponding to a received request from the system under test based on a distance measure; and
computer readable code to generate a response to the request using the one of the message clusters that was identified.
